(19) United States
(12) Patent Application Publication
(10) Pub. No.: US 2016/0321641 A1
(43) Pub. Date: Nov. 3, 2016

(54) Systems and Methods for Facilitating Mobile Banking to Provide Current Bank Account Balances to Mobile Devices

(71) Applicant: Huntington Bancshares Incorporated, Columbus, OH (US)

(72) Inventors: Scott D. Cady, Dublin, OH (US); Robert A. O'Malley, Hilliard, OH (US); Jill Tubaugh, Westerville, OH (US)

(21) Appl. No.: 14/702,416

(22) Filed: May 1, 2015

(51) Int. Cl. G06Q 20/32; G06Q 20/10

(52) U.S. Cl. CPC G06Q 20/3223; G06Q 20/108; G06Q 20/3221; G06Q 20/3226

(57) ABSTRACT

A mobile banking system and method quickly and securely provides current financial account balances to mobile electronic devices. A bank server electronically receives, from a mobile electronic device, a username and a request to receive at least one current financial account balance while the user is not fully logged-in. Full log-in typically requires receipt and validation of both the username and an associated password. The bank server first validates the username against stored user credentials, and only if the username is valid, proceeds to validate registration of the mobile electronic device sending the username. Registration is validated by verifying that a serial number from an authentication seed previously stored on the sending mobile electronic device matches its stored expected value. If the registration is valid, the bank server obtains data for the at least one current financial account balance and sends the data to the mobile electronic device.

### CROSS-REFERENCE TO RELATED APPLICATIONS

Not Applicable

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to systems and methods for facilitating banking and, more particularly, to such systems and methods which facilitate mobile banking.

### BACKGROUND OF THE INVENTION

Mobile banking is a system that allows customers of a financial institution to conduct financial transactions through a mobile device such as a mobile phone or tablet. Mobile banking differs from mobile payments, which involve the use of a mobile device to pay for goods or services either at the point of sale or remotely. The earliest mobile banking services were offered over short message service (SMS), a service known as SMS banking. With the introduction of smart phones with wireless application protocol (WAP) support enabling the use of the mobile web, banks started to offer mobile banking on this platform to their customers. Apple®'s initial success with iPhone® and the rapid growth of phones based on Google®'s Android® (operating system) have led to increasing use of special client programs, called applications or apps, downloaded to the mobile device. The rapid adoption of mobile apps and other advancements in web technologies has resulted in many banks launching mobile web based services to complement native applications.

Mobile banking services may include: account information services such as mini-statements and checking of account history, and alerts on account activity or passing of set thresholds: transaction services such as funds transfers between the customer's linked accounts, paying third parties, including bill payments, and check remote deposit; support services such as exchange of data messages and email including complaint submission and tracking: and content services such as general information and location-based services.

Strict security of financial transactions is required because of the sensitive nature of the information. This strict security often comes at the cost of consumer convenience. Thus there is a continuous desire to improve customer convenience without sacrificing security. For example, customers desire a way to quickly and easily view current account balances but adequate security means must be present due to the sensitive nature of the information. Accordingly, there is a need for improved systems and methods for facilitating mobile banking to quickly and securely provide account balances to mobile electronic devices.

### SUMMARY OF THE INVENTION

Disclosed are systems, methods, and software for facilitating mobile banking which address one or more issues of the related art as described above. Disclosed is a computer implemented method for facilitating mobile banking. The method comprises the steps of, in combination, electronically receiving, from a mobile electronic device, a username and a request to receive at least one financial account balance while a user associated with the username is not fully logged-in (wherein full log-in requires receipt and validation of the username and an associated password), electronically validating the username, and electronically validating registration of the mobile electronic device. If the username is valid and the registration of the mobile electronic device is valid, data for the at least one financial account balance is electronically obtained and electronically sent to the mobile electronic device for display.

Also disclosed is a system for facilitating mobile banking. The system comprises, in combination, at least one central computer having memory, a processor in communication with the memory, and a network interface in communication with the processor for communicating with mobile electronic devices. The memory comprises computer-executable instructions executable by the processor to perform the steps of electronically receiving, from a mobile electronic device, a username and a request to receive at least one financial account balance while a user associated with the username is not fully logged-in (wherein full log-in requires receipt and validation of the username and an associated password), electronically validating the username, and electronically validating registration of the mobile electronic device. If the username is valid and the registration of the mobile electronic device is valid, data for the at least one financial account balance is electronically obtained and electronically sent to the mobile electronic device for display.

Also disclosed is one or more computer-readable media storing an application for facilitating mobile banking comprising computer-executable instructions that responsive to execution cause operations to be performed. The operations performed comprise, in combination, electronically receiving, from a mobile electronic device, a username and a request to receive at least one financial account balance while a user associated with the username is not fully logged-in (wherein full log-in requires receipt and validation of the username and an associated password), electronically validating the username, and electronically validating registration of the mobile electronic device. If the username is valid and the registration of the mobile electronic device is valid, data for the at least one financial account balance is electronically obtained and electronically sent to the mobile electronic device for display.

From the foregoing disclosure and the following more detailed description of various preferred embodiments it will be apparent to those skilled in the art that the present invention provides a significant advance in the technology and art of systems and methods for facilitating online banking. Particularly significant in this regard is the potential the invention affords for providing systems and methods for facilitating mobile banking that provide a positive user experience through quick and secure account balance information. Additional features and advantages of various preferred embodiments will be better understood in view of the detailed description provided below.

### BRIEF DESCRIPTION OF THE DRAWINGS

These and further features of the present invention will be apparent with reference to the following description and drawings.

FIG. 1 is schematic view of a mobile system according to the present invention.

FIG. 2A is schematic view of an exemplary financial institution or bank server or computer of the system of FIG. 1.

FIG. 2B is schematic view of an exemplary mobile electronic device of the system of FIG. 1.

FIG. 3 is schematic view of an exemplary user mobile electronic device of the system of FIG. 1, wherein the mobile electronic device has a mobile banking application or module installed thereon.

FIG. 4 is front view of the exemplary user mobile electronic device of FIG. 3 with the mobile banking application displaying an exemplary initial login page with a quick balance feature introduction or description.

FIG. 5 is a front view of the exemplary user mobile electronic device of FIGS. 3 and 4 with the mobile banking application displaying a settings page for enablement of a quick balance module when a quick balance toggle control button is in an off position.

FIG. 6 is a front view of the exemplary user mobile electronic device of FIGS. 3 to 5 with the mobile banking application displaying the settings page of FIG. 5 but with a reminder unhidden.

FIG. 7 is a front view of the exemplary user mobile electronic device of FIGS. 3 to 6 wherein the mobile banking application is displaying settings page of FIGS. 5 and 6 but with the quick balance toggle control button in an on position and a user disclaimer is presented.

FIG. 8 is a front view of the exemplary user mobile electronic device of FIGS. 3 to 7 wherein the mobile banking application is displaying the settings page of FIG. 5 but with the quick balance module turned on, giving the user the ability to select eligible accounts for the quick balance display module.

FIG. 9 is a front view of the exemplary user mobile electronic device of FIGS. 3 to 8 wherein the mobile banking application is displaying a settings module menu page with the quick balance module turned off.

FIG. 10 is a front view of the exemplary user mobile electronic device of FIGS. 3 to 9 wherein the mobile banking application is displaying the settings module menu page similar to FIG. 9 but wherein the quick balance module is turned on.

FIG. 11 is front view of the exemplary user mobile electronic device of FIGS. 3 to 10 wherein the mobile banking application is displaying the login page similar to FIG. 4 but without the quick balance link introduction.

FIG. 12 is front view of the exemplary user mobile electronic device of FIGS. 3 to 11 wherein the mobile banking application is displaying the login page or similar to FIG. 11 but with current account balances displayed.

FIG. 13 is front view of the exemplary user mobile electronic device of FIGS. 3 to 12 wherein the mobile banking application is displaying an exemplary main account interface page.

FIG. 14 is a sequence diagram for registering a mobile electronic device using the mobile banking application of the mobile banking system of FIG. 1.

FIG. 15 is a sequence diagram for a configuration module of the mobile banking application of the mobile banking system of FIG. 1.

FIG. 16 is a sequence diagram for an interface module of the mobile banking application of the mobile banking system of FIG. 1.

FIG. 17 is a process flow diagram showing interaction between a user interface and a display module of the mobile banking application of the mobile banking system of FIG. 1.

FIG. 18 is a process flow diagram showing interaction between a user interface and a display module of the mobile banking application of the mobile banking system of FIG. 1.

FIG. 19 is a schematic view of a mobile system according to the present invention similar to FIG. 1 but showing that a mobile electronic device can have a plurality of authorized users and a single user can utilize a plurality mobile electronic devices via a single user account.

It should be understood that the appended drawings are not necessarily to scale, presenting a somewhat simplified representation of various preferred features illustrative of the basic principles of the invention. The specific design features of the systems as disclosed herein, including specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened for clarity or illustration. All references to direction and position, unless otherwise indicated, refer to the orientation of the systems illustrated in the drawings.

### DETAILED DESCRIPTION OF CERTAIN DISCLOSED EMBODIMENTS

It will be apparent to those skilled in the art, that is, to those who have knowledge or experience in this area of technology, that many uses and design variations are possible for the systems, methods, and software for electronically facilitating mobile banking as disclosed herein. The following detailed discussion of various alternative and preferred embodiments will illustrate the general principles of the invention with regard to a particular embodiment. Other embodiments suitable for other applications will be apparent to those skilled in the art given the benefit of this disclosure.

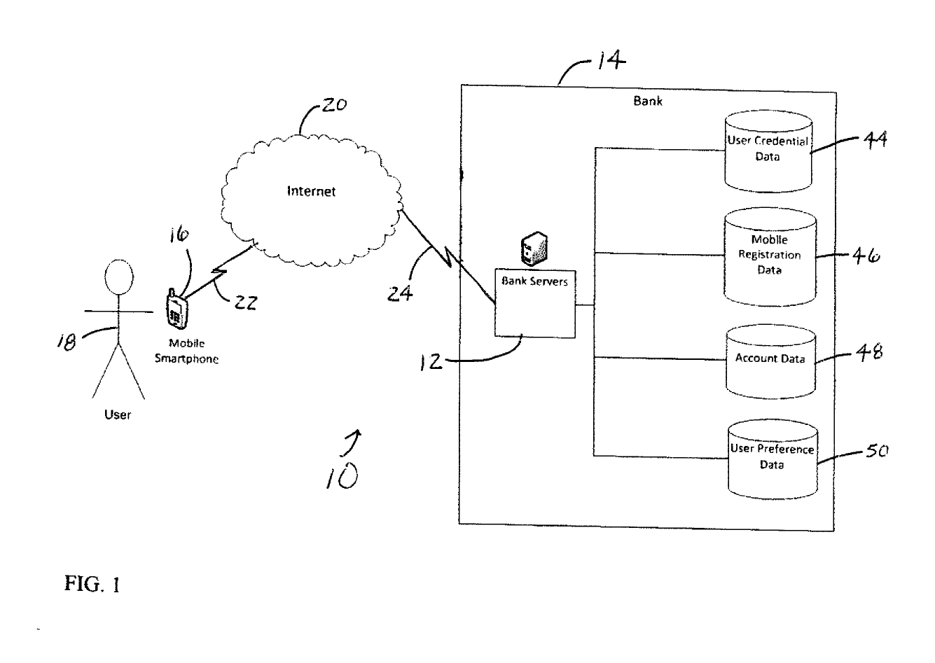

Referring now to the drawings, FIG. 1 illustrates a system (10) for electronically facilitating mobile banking according to the present invention. The illustrated system (10) includes a service provider or bank server or computer (12) located at a service provider or bank (14), and a mobile or portable electronic device (16) of a user (18). While the illustrated service provider (14) is a bank, it is noted that the service provider (14) can alternatively be any other suitable type of financial institution. The term “server” is used in the specification and claims to mean a computer configured to manage, store, send and process data 24-hours a day. The term “computer” is used in the specification and claims to mean any electronic device that can suitably communicate via a computer network including, but not limited to, desktop computers, laptop computers, notebook computers, tablet computers, smart phones, personal digital assistants (PDAs), digital cameras, mp3 players, video game systems, messaging systems, video players, smart televisions, and the like. The terms “portable electronic device”, “mobile electronic device”, and “mobile device” are used in the specification and claims to mean a handheld electronic device that utilizes rechargeable batteries as a power source and that that can suitably communicate with the bank server (12) via the computer network including, but not limited to, smart phones, personal digital assistants (PDAs), mp3 or other music players, video game players, messaging systems, tablet computers, notebook computers, wearable devices, and the like

The illustrated bank server (12) and the illustrated mobile electronic device (16) are in electronic communication with one another via a communication system (20). The illustrated communication system (20) is a computer network such as the Internet but any other suitable communication system (20) can alternatively be utilized such as, but not limited to, an intranet, any other type network of computers, and the like. The illustrated bank server (12) is in communication with the communication system (20) via a network connection (22) of any suitable type. The illustrated mobile electronic device (16) is in communication with the communication system (20) via a wireless connection (24) of any suitable type.

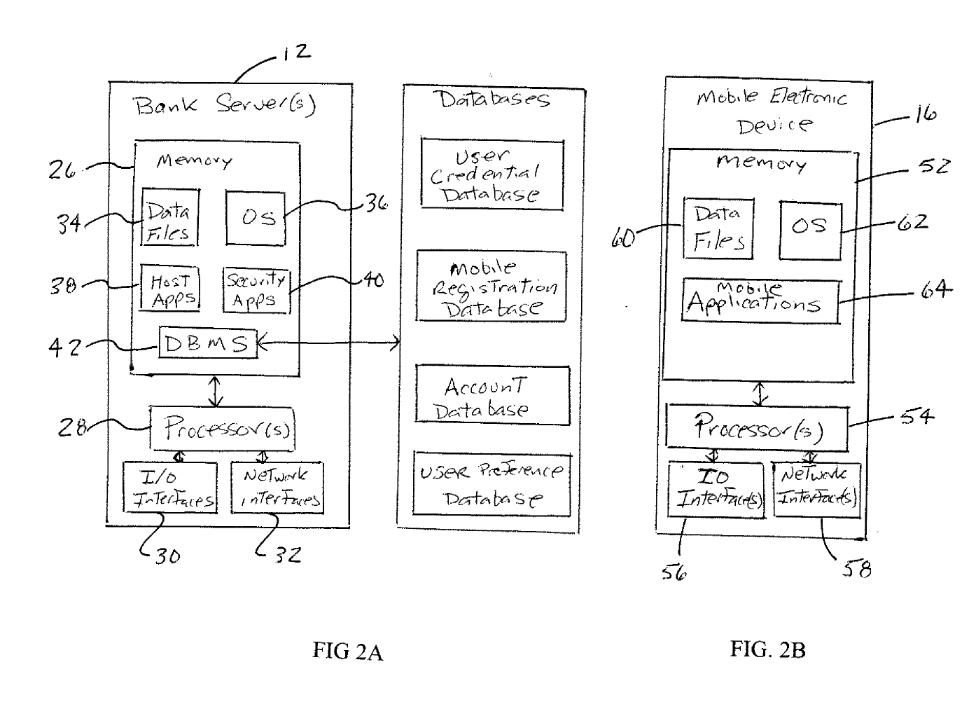

The illustrated bank server or computer (12) includes memory (26), at least one processor or central processing units (CPU) (28) in communication with the memory (26), at last one input/output (I/O) interface (30) in communication with the processor (28), and at least one network interface (32) in communication with the processor (28) (best shown in FIG. 2A). These components are all configured to carry out the functions and steps described herein. The illustrated memory (26) stores data files (34), an operating system (OS (36)), host applications (38) for communications with web browsers and mobile applications, security applications (40) for limiting access to authorized users (18), and a database management system (42) for interfacing with databases having stored information. It is noted that any other suitable information and/or software can be stored in the processor (28) and/or the memory (26). The illustrated databases (44, 46, 38, 50) are separate from the bank server or computer (12) but it is noted that the databases (44, 46, 38, 50) can alternatively be integrated with the bank server or computer (12). The illustrated databases (44, 46, 38, 50) are located at the bank (14) but it is noted that the databases (44, 46, 38, 50) can alternatively be located at any other suitable location, such as a cloud location and/or be of any other suitable type. The illustrated databases (44, 46, 38, 50) include a user credential database (44), a mobile registration database (46), an account database (48), and a user preference database (50) but any other suitable types of databases (44, 46, 38, 50) can alternatively or additionally be utilized. The processor (28) can be of any suitable type. The I/O interface (30) can be of any suitable type such as, but not limited to, a display, monitor, keyboard, mouse, track ball, touch pad, joy stick, camera, speaker, printer, modem, disk drive, and the like. The network interface (32) can be of any suitable type such as, but not limited to, a network interface card, software simulating a network card, and the like. The illustrated processor (28) and memory (26) are programmed with system software for facilitating mobile banking including providing a web portal for interfacing with the user mobile electronic devices (16) as described in more detail hereinafter.

The illustrated bank server or computer (12) is located at the bank (14) and can be accessed by customers or users (18) at remote locations via the communication system (20). It is noted that while the illustrated system (10) shows a single bank server or computer (12), it should be appreciated that the system (10) typically has a large number of bank servers or computers (12). It is also noted that the bank server (12) is not necessarily physically located at physical facilities of the bank (14). In many instances one or more servers (12) are located at other locations such as cloud based.

The illustrated user mobile electronic device (16) includes memory or a memory module (52) for retaining information, at least one processor module or central processing unit (CPU) (54) for processing computer instructions, calculations, and logic and in communication with the memory (52), at least one input/output (IO) interface (56) such as, but not limited to a display module or touch-screen display for enabling the fast and efficient visual display of information and user interface elements to the user (18) and in communication with the processor (54), and at least one communications module or network interface (58) for wireless communication of data to and from Internet based servers using either a wide area telephony based network carrier, a wifi connection, or the like and in communication with the processor (best shown in FIG. 2B). These components are configured to carry out the functions and steps described herein. The illustrated memory (52) stores data files (60), an operating system (OS) (62), and a mobile banking application or app (64). It is noted that any other suitable information and/or software can be stored in the processor (54) and/or memory (52). The processor (54) can be of any suitable type. The I/O interface (56) can be of any suitable type such as, but not limited to, a touch-screen display, display, keyboard, keypad, mouse, track ball, touch pad, joy stick, camera, speaker, and the like. The network interface (58) can be of any suitable type such as, but not limited to, a network interface card, software simulating a network card, and the like. The illustrated processor (54) and memory (52) are programmed with the mobile banking application or app (64) for communicating with the bank server (12) as described in more detail hereinafter. The terms “mobile app” and “mobile application” are used in the specification and claims to mean a type of application software designed to run on a mobile electronic device (16) such as a smartphone or tablet to provide the user (18) with similar services to those accessed on desktop personal computers and the like.

The illustrated user mobile electronic device (16) is a mobile smartphone and is physically located with the customer or user (18), and is most often located at a location remote from the bank (14). It is noted that while the illustrated system (10) shows a single customer or user (18), it should be appreciated that the system (10) typically has a large number of customers or users (18) interfacing with the bank server (12) with a large number of mobile electronic devices (16). The illustrated mobile electronic device (16) is loaded with the customized mobile banking application (64) or configured to interface with system software residing on the bank server or computer (12) at the bank (14). The mobile banking application or app (64) can be downloaded from one of the public app stores such as Apple App Store or Google Play, so that it resides in the memory module (52) of the mobile electronic device (16) ready to be launched by the user (18).

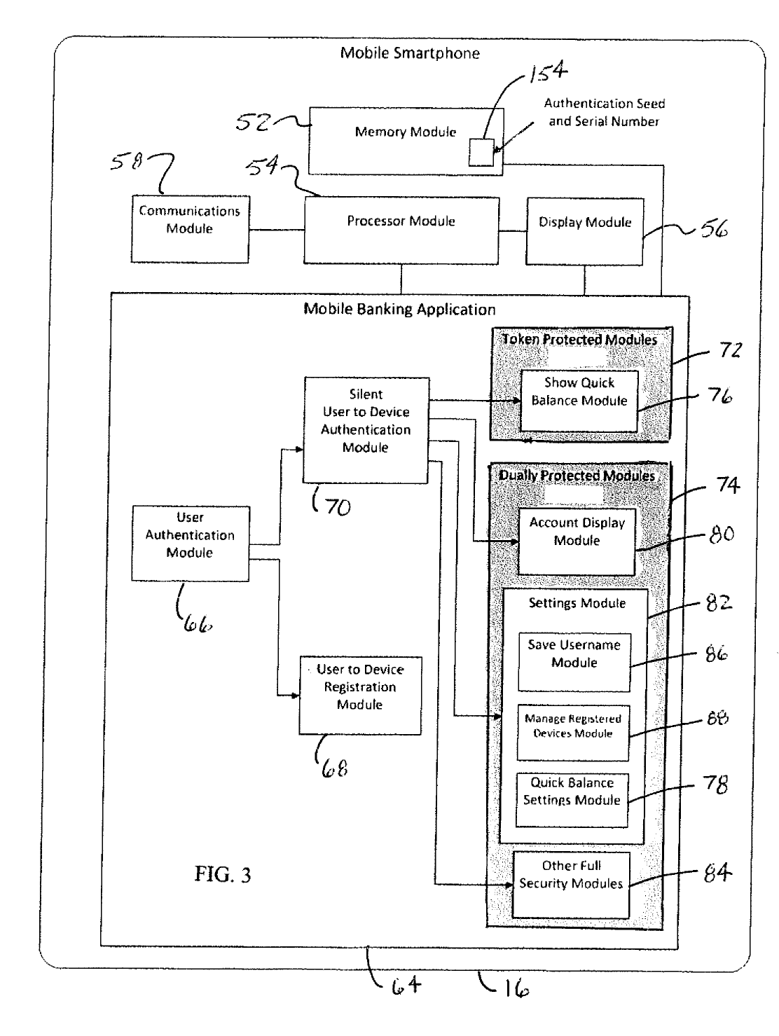

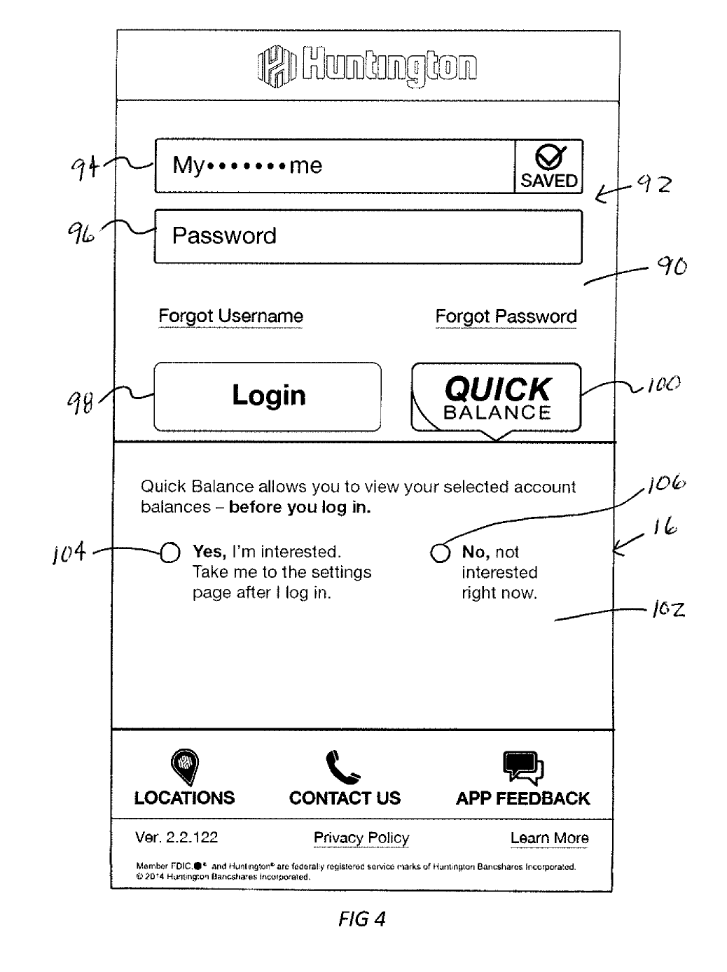

FIG. 3 shows the illustrated mobile electronic device (16) with the illustrated mobile banking application (64) stored in memory. The illustrated mobile banking application (64) is a full service mobile banking application providing access to bank account information and transaction history, ability to make payments from bank accounts, ability to transfer funds between bank accounts, and the ability to make deposits to bank accounts. The illustrated mobile banking application (64) also includes a quick balance module feature with which the user (18) can quickly obtain current bank account balances without fully logging in to the mobile banking system (10). The bank accounts can include any suitable bank products and/or sub products such as deposit accounts, savings accounts, personal money market accounts, credit card accounts, loan accounts, certificate of deposit accounts, and the like.

The illustrated mobile banking app (64) includes several modules that permit a user (18) to set up and use the quick balance feature. These modules include: (1) a user authentication module (66) for enabling the user (18) to log into the mobile banking application (64) with their username and password credentials; (2) a user to device registration module (68) for enabling the user (18) to register the mobile banking application (64) by entering a one-time use passcode sent to them from the bank (14) using email or an SMS text message (if the passcode is successfully entered, an authentication seed and serial number are stored in the memory module (52) of the mobile electronic device (16) storing the mobile banking application (64)); (3) a user to device authentication module (70) which silently coordinates with the bank server(s) (12) to determine whether the user and device combination has previously registered using the user to device registration module (68) and is therefore authenticated to access the user's current bank account balances; (4) token protected modules (72) which require authentication using only the username (which can be stored on the mobile electronic device (16)) and not full login authentication (username and password) and the silent user to device authentication module (70); and (5) dually protected modules (74) which require full login authentication with username and password authentication and silent user to device authentication module (70). Features or functions requiring token protection without full login include the viewing the current balance of account(s). Features or functions requiring dual protection or full login include viewing full account details, viewing account history, making payments, adding/editing payees, making transfers or making deposits, and other like functions. The illustrated token protected modules (72) include, but are not limited to, a show quick balance module (76) which allows the user (18) who has been silently authenticated by the silent user to device authentication module (70) to see current balances for the bank accounts they previously selected using a quick balance settings module (78) described below. The illustrated dually protected modules (74) include, but are not limited to: an account display module (80) which is where the user (18) lands upon successful login using their full username and password and 2^{nd} factor registration credentials; a payments module; a transfers module; a deposits module; a settings module (82) for enabling the user (18) to save their username, manage registered mobile electronic devices (16), and turn the quick balance feature on and off; and other full security modules (84) for enabling mobile banking features and functions. The illustrated settings module (82) includes: a save username module (86) for saving the user's username so that the username is pre-populated the next time the user (18) launches the mobile banking application (64); a manage registered devices module (88) for enabling the user (18) to see a list of mobile electronic devices (16) previously registered and to delete any prior mobile electronic device registration if desired; and the quick balance settings module (78) for enabling the user (18) to ‘turn on’ the quick balance feature and to choose which of their bank accounts they want current balances to be shown when requested with the quick balance feature.

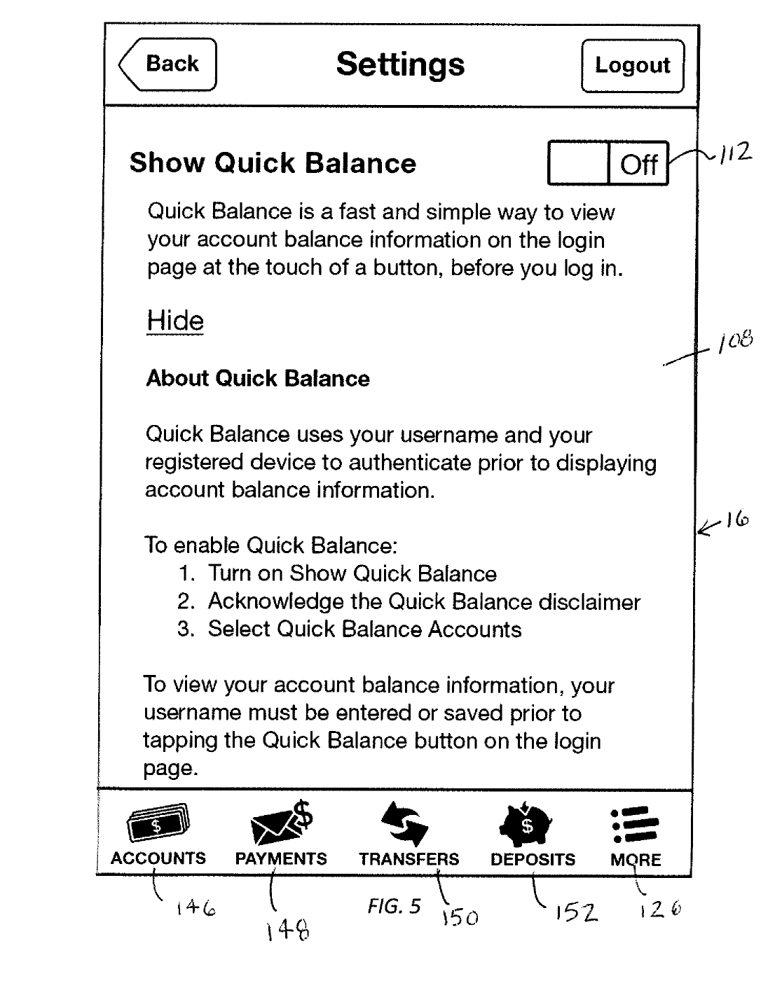

FIG. 4 illustrates the user's mobile electronic device (16) with the mobile banking application (64) displaying a login page (90) as it appears upon initial activation of the mobile banking application (64), that is, when the mobile banking application (64) is first used and prior to login of any user (18). This initial display of the login page (90) displays the show quick balance module (76) and displays a login interface (92) that is configured to receive initial authentication of a user (18) to enable initial access for the user (18) to the account display module (80) and to the quick balance settings module (78). The illustrated login interface (92) includes a first or username text entry field (94), a second or password text entry field (96), and a login activation button (98) for activating the dual authentication login process by the user (18). It is noted that login interface (92) can alternatively or additionally have any other suitable components and/or the user interface elements (94, 96, 98) can alternatively be of any other suitable type. The illustrated login page (90) also displays a quick balance activation button (100). The illustrated quick balance activation button (100) can be tapped to toggle the display (102) of the quick balance module (76). The illustrated login page (90) further displays an introduction and/or description of the quick balance feature along with user interface elements (104, 106), in the form of yes and no buttons, for determining whether the user (18) wants to proceed with setting up the quick balance feature on their mobile electronic device (16). It is noted that this quick balance interface or display (102) can alternatively or additionally have any other suitable components and/or the user interface elements (104, 106) can alternatively be of any other suitable type. If a user (18) taps the yes button (104), a settings page (108) of the settings module (82) is displayed (see FIG. 5) upon successful user (18) and user-device (16) authentication. If a user (18) taps the no button (106) or takes no action with regard to the yes and no buttons (104, 106), the mobile banking application (64) will not display the quick balance module (76) opened on the login page (90) again to the user (18) and will navigate the user (18) to the accounts display module (80) upon successful user (18) and user-device (16) authentication. It is noted that this initial login page (90) can alternatively or additionally have any other suitable components and/or can alternatively have any other suitable form.

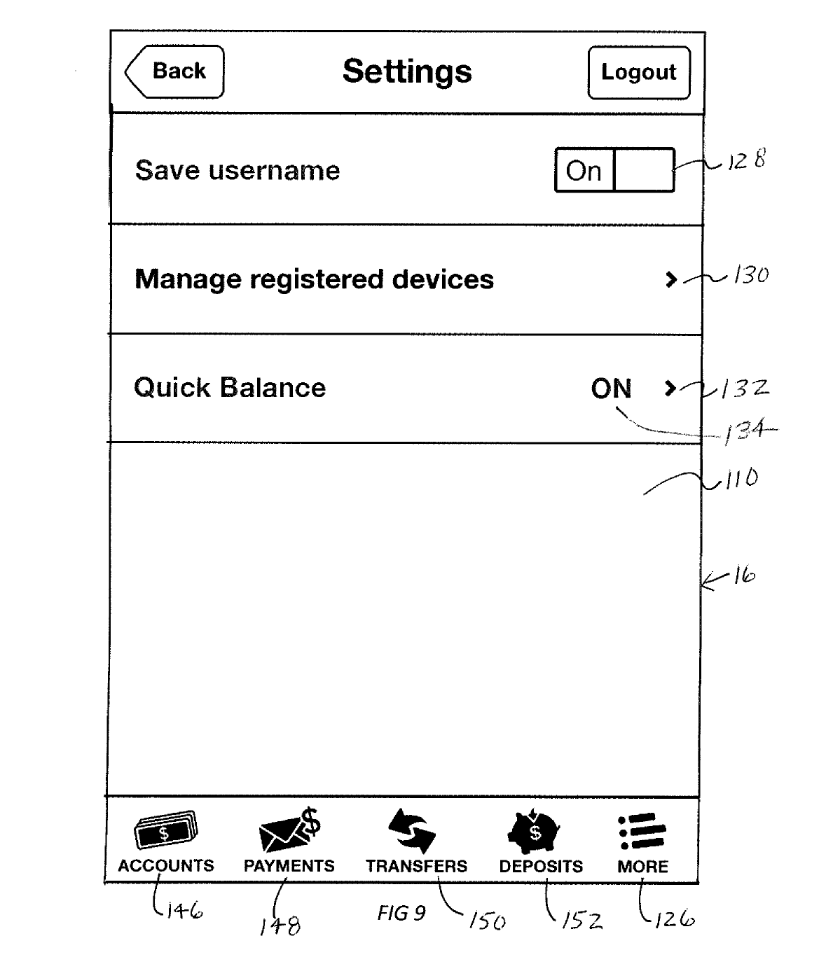

FIG. 5 illustrates the user's mobile electronic device (16) with the mobile banking application (64) displaying an initial settings page (108) of the quick balance settings module (78) as it appears upon successful user (18) and user-device (16) authentication with the yes option (104) selected on the initial login page (90) (see FIG. 4) or when accessed via the settings menu page (110) of the settings module (82) (see FIG. 9). The illustrated settings page (108) includes a show quick balance toggle control button (112) that the user (18) can toggle between off and on. The illustrated show quick balance toggle control button (112) is initially off by default. It is noted that the show quick balance toggle control button (112) can alternatively be any other suitable type of user interface element or can alternatively be of any other suitable type of toggle control. The illustrated settings page (108) includes descriptions of the show quick balance module (76) and other quick balance modules. With this information, the user (18) can make a decision regarding the enablement of the show quick balance module (76) using the show quick balance toggle control button (112). It is noted that the settings page (108) can alternatively or additionally have any other suitable components and/or can alternatively have any other suitable form.

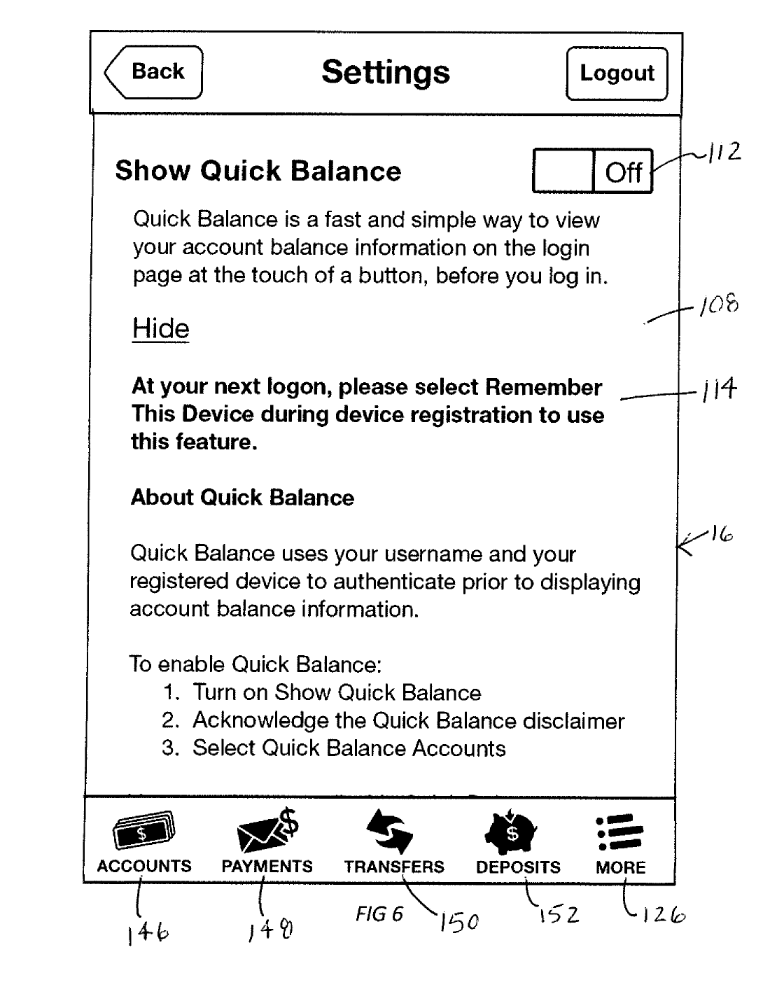

FIG. 6 illustrates the user's mobile electronic device (16) with the mobile banking application (64) displaying a reminder version of the settings page (108) of the settings module (78) as it appears upon (1) successful user (18) and user-device (16) authentication with the yes option selected on the initial login-page (90) (see FIG. 4) or when accessed via the settings module (82) (see FIG. 9), and (2) the user (18) has not selected to trust or remember the user's mobile electronic device (16) during the user-device registration module (68). If the user (18) selected to trust or remember the user's mobile electronic device (16) during the user-device registration module (68), the regular settings module (82) (see FIG. 5) is displayed in these two instances instead. This reminder version of the settings page (108) is the same as the regular settings page (82) except that (1) the show quick balance toggle control button (112) is off and remains off because it is not selectable by the user (18) because the quick balance feature is only permitted on registered/trusted mobile electronic devices (16), and (2) a reminder (114) is displayed to the user (18) that at the next logon, they need to remember this electronic mobile device (16) during device registration in order to use the quick balance feature. It is noted that the reminder version of the settings page (108) can alternatively or additionally have any other suitable components and/or can alternatively have any other suitable form.

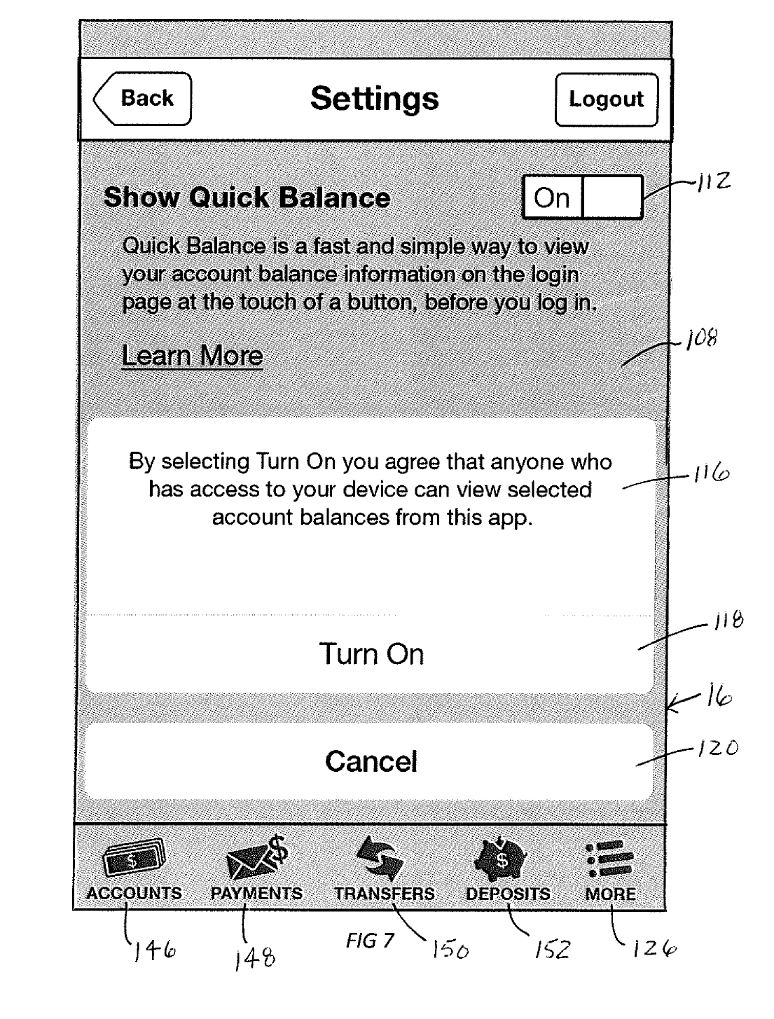

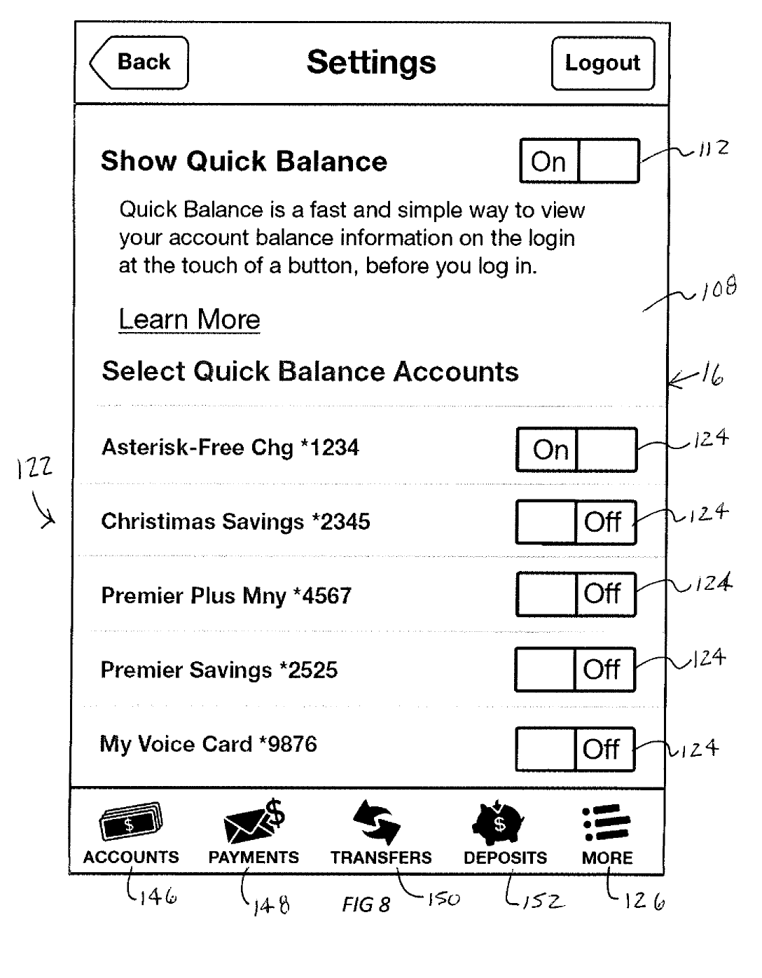

FIG. 7 illustrates the user's mobile electronic device (16) with the mobile banking application (64) displaying a disclaimer version of the quick balance settings page (108) of the settings module (82) as it appears upon activating the show quick balance toggle control button (112) from the off position to the on position. A disclaimer (116) is displayed that informs the user (18) that turning the quick balance feature on will permit anyone who has access to the mobile electronic device (16) to view selected account balances from the mobile banking application (64). The disclaimer (116) must be agreed to by the user (18) in order to enable the quick balance module (76). The user (18) must acknowledge the disclaimer (116) by tapping a turn on button (118). It is noted that the turn on button (118) can alternatively be any other suitable type of user interface element. Activating the turn on button (118) enables the quick balance module (76) and further configures the quick balance module (76) through the quick balance settings module (78). If the user (18) has enabled the quick balance module (76) and acknowledged the disclaimer (116), the quick balance module (76) stores a property on the mobile electronic device (16) identifying that the quick balance module (76) is enabled for this user (18). If the customer (18) does not want to acknowledge the disclaimer (116), they can tap a cancel button (120) and the show quick balance toggle control button (12) automatically moves from the on position to the off position and the mobile banking application (64) automatically returns to the initial settings page (108) (see FIG. 5). It is noted that the cancel button (120) can alternatively be any other suitable type of user interface element. It is noted that the disclaimer version of the settings page (108) can alternatively or additionally have any other suitable components and/or can alternatively have any other suitable form.

After the customer acknowledges the disclaimer (116) (see FIG. 7), the bank server (12) determines all of the user's accounts with the bank (14) that are eligible for use with the quick balance feature. An eligible account is any bank account that the user (18) is listed as the current owner or joint-owner and one that has been configured as allowable within the quick balance module (76). It is noted, however, that the mobile banking application (64) will later only display current bank account balances for bank accounts the user (18) is listed as the current owner or joint-owner at the time of the request for the current bank account balance information regardless of ownership at the time the user (18) interacts with the quick balance settings module. The bank server (12) then returns the user's quick balance module-eligible bank accounts for configuration.

FIG. 8 illustrates the user's mobile electronic device (16) with the mobile banking application (64) displaying a select accounts version of the settings page (108) of the settings module (82) as it appears upon acknowledging the disclaimer (116). The illustrated select accounts version of the settings page (108) displays a list of names of the user's accounts (122) with the bank (14) that are eligible for use with the quick balance feature. A select account toggle control button (124) is provided next to each of the user's eligible accounts (122) that the user (18) can toggle between off and on. The illustrated select account toggle control button (124) is initially off by default. It is noted that the select account toggle control button (124) can alternatively be any other suitable type of user interface element or can alternatively be of any other suitable type of toggle control. To enable an eligible bank account (122) for the quick balance module (76), the user (18) taps the toggle control button (124) next to the selected eligible bank account (122) so it that moves from the off position to the on position. To disable an eligible bank account (122) for the quick balance module, (76) the user (18) taps the toggle control button (124) next to the selected eligible bank account (122) so that it moves from the on position to the off position. These account-level settings are immediately saved to a bank database to be accessed later upon activation of the quick balance module (76). It is noted that the select accounts version of the settings page (108) can alternatively or additionally have any other suitable components and/or can alternatively have any other suitable form.

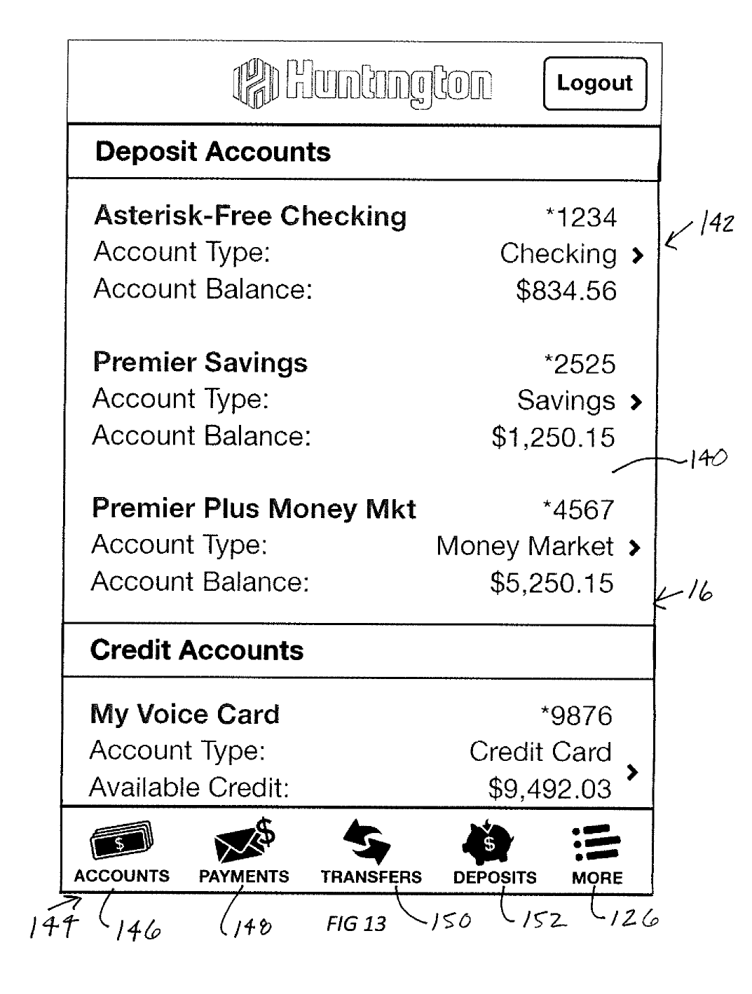

FIG. 9 illustrates the user's mobile electronic device (16) with the mobile banking application (64) displaying a main settings or settings module menu page (110) of the settings module (82) which allows the user (18) to save the username, manage registered mobile electronic devices (16), and configure the quick balance module (76) in the quick balance settings module (78). In this illustrated embodiment, the settings module menu page (110) is accessed after successful authentication through the “MORE” menu option (126) in an account display module (80) (see FIG. 13) and selecting “Settings”. The illustrated settings module menu page (110) includes a save username toggle control button (128) that the user (18) can toggle between off and on depending on whether the user (18) wants to save their username or not. If the username is saved, the username will automatically populate on the login page (90). It is noted that the save username toggle control button (128) can alternatively be any other suitable type of user interface element or can alternatively be of any other suitable type of toggle control. The illustrated settings module menu page (110) also includes a link (130) to a managed registered devices page where the user (18) can view and/or delete mobile electronic devices (16). It is noted that the user interface element (130) can alternatively be of any other suitable type. The illustrated settings module menu page (110) further includes a link (132) to the quick balance settings module (78) where the user (18) can configure the quick balance module (76). It is noted that the user interface element (132) can alternatively be of any other suitable type. The current enablement status (134) of the quick balance module (76) is displayed next to the link (132). The illustrated current status (134) shows the quick balance module (76) enabled (ON). It is noted that the settings module menu page (110) can alternatively or additionally have any other suitable components and/or can alternatively have any other suitable form.

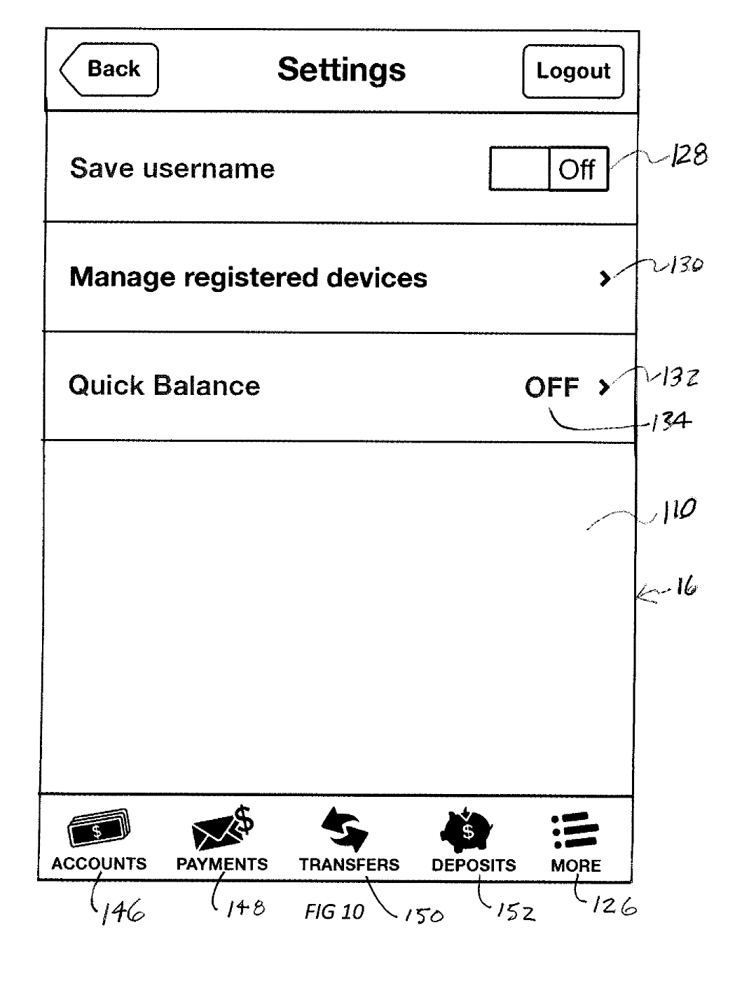

FIG. 10 illustrates the user's mobile electronic device (16) with the mobile banking application (64) displaying a main settings or settings module menu page (110) of the settings module similar (82) to FIG. 9. However, the save username toggle control button (128) is in the off position and the illustrated current status (134) shows the quick balance module (76) disabled (OFF).

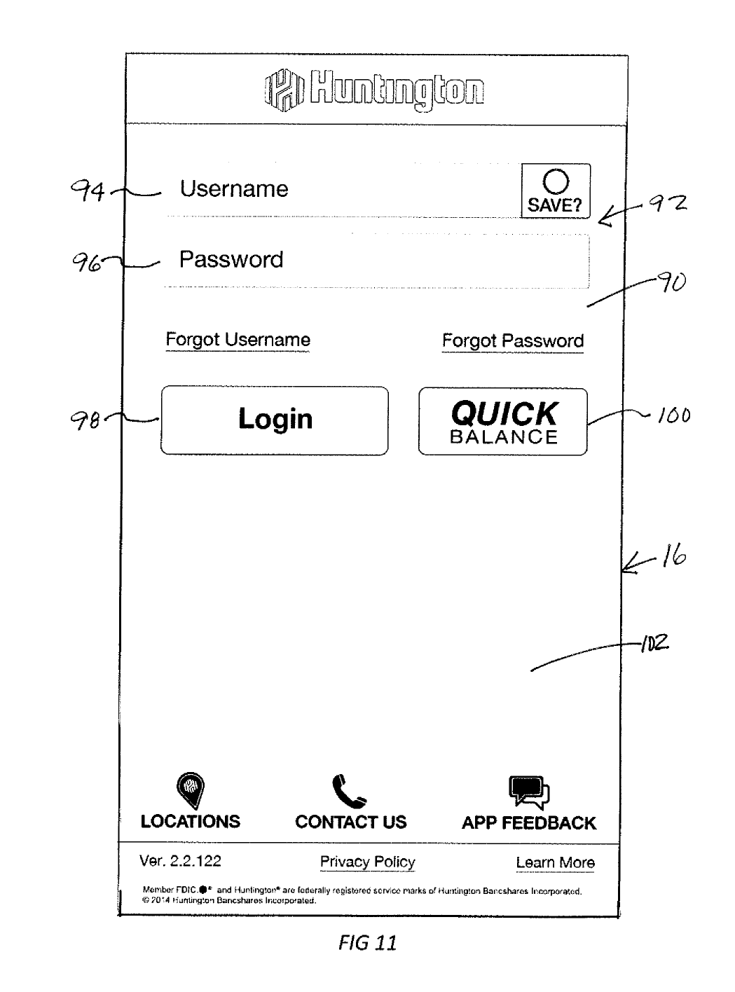

FIG. 11 illustrates the user's mobile electronic device (16) with the mobile banking application (64) displaying the login page (90) of the mobile banking module or application (64) as it appears upon activation of the mobile electronic device (16) after the first time and prior to any login of any user (18) or one who wishes to not save a username. Thus no username has been saved. Accordingly, the login interface (92) is configured to receive initial authentication of a user (18) to enable initial access to the account display module (80) and/or to receive a username to activate the quick balance module (76). It is noted that the quick balance module (76) will not present current account balances until the user (18) has enabled and configured the quick balance module (76). It is also noted that the login page (90) can alternatively or additionally have any other suitable components and/or can alternatively have any other suitable form.

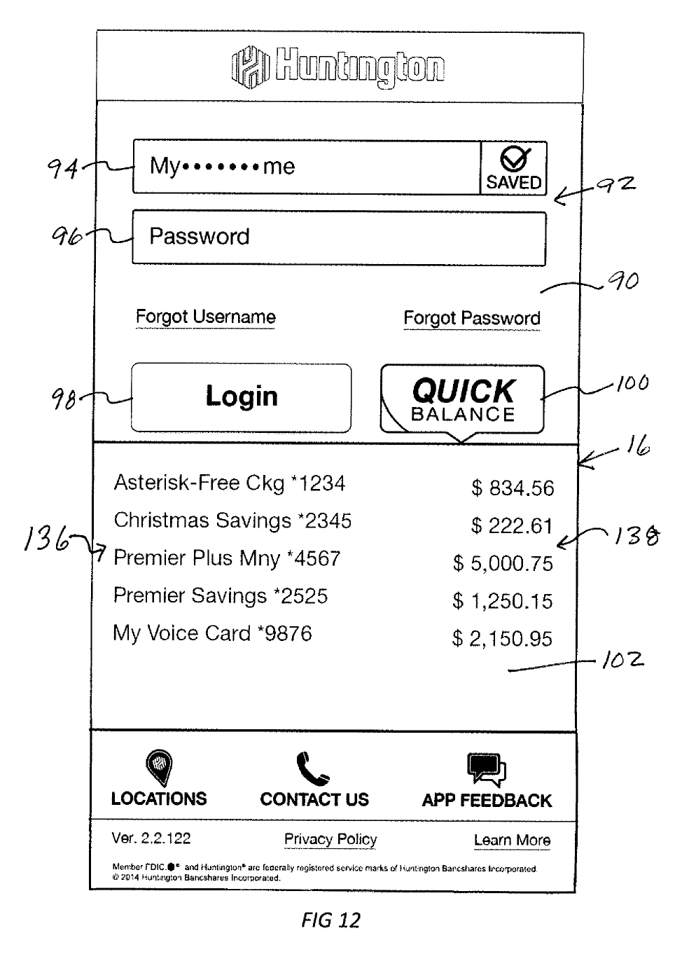

FIG. 12 illustrates the user's mobile electronic device (16) with the mobile banking application (64) displaying the login page (90) of the mobile banking module or application (64) as it appears after the user (18) activated and configured the quick balance module (76) and entered and/or saved a username. Bank account names and balances are displayed in a list for each enabled, eligible bank account (122) configured by the user (18). The illustrated quick balance module (76) does not display any bank account names and balances that have not been previously configured by the user (18) after successfully logging in via the initial authentication and device registration. The illustrated quick balance module (76) closes after a predetermined time period of none activity such as two minutes. It is also noted that the login page (90) can alternatively or additionally have any other suitable components and/or can alternatively have any other suitable form.

FIG. 13 illustrates the user's mobile electronic device (16) with the mobile banking application (64) displaying main accounts page or dashboard (140) of the account display module (80) of the mobile banking module or application (64) as it appears once the user (18) has logged in to the mobile banking application (64) via the login interface (92) of the login page (90). The account display module (80) comprises several tools for interfacing with the main account module. The main account module can receive and display account balances of bank accounts (142) and/or further account information about each bank account (142) such as summary information, pending transactions, posted transactions and transaction receipts throughout a predetermined time period. Within the main accounts page (140), the user (18) can access other bank modules within the mobile banking module (64) through a row of a plurality links (144) located at the bottom of the display. The illustrated plurality of links (144) includes an “ACCOUNTS” link (146) which when activated takes the user (18) to this main accounts page (140) of the accounts display module (80), a “PAYMENTS” link (148) which when activated takes the user (18) to a payments module, a “TRANSFERS” link (150) which when activated takes the user (18) to a transfers module, a DEPOSITS” link (152) which when activated takes the user (18) to a deposits module, and the “MORE” link (126) which when activated displays a pull down menu of a plurality of different pages which the user (18) can select such as “SETTINGS” (108) page (see FIG. 9). It is noted that the plurality of links (144) can have other quantities and/or types of links and/or the user interface elements can alternatively be of any other suitable type. The payments module can be configured to permit the user (18) to pay bills, add bill pay payees, edit bill pay payees, delete bill pay payees, and manage scheduled payments. The transfer module can be configured to permit the user (18) to transfer funds between eligible accounts and manage scheduled transfers. The deposits module can be configured to permit the user (18) to deposit a check into a bank account, via photo capture where a picture of the check to be deposited is sent to bank server (12) for processing and deposit and view deposit history. It is also noted that the accounts page (140) can alternatively or additionally have any other suitable components and/or can alternatively have any other suitable form.

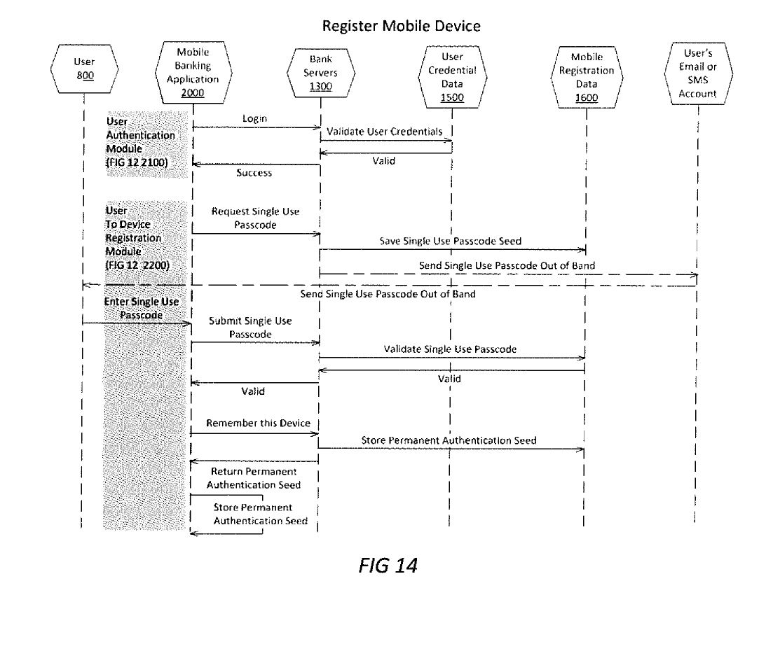

FIG. 14 illustrates a sequence diagram for registering a mobile electronic device (16) for use of the mobile banking application (64) for a user (18). The illustrated sequence of events for registration is:

(1) User directs the mobile banking application (64) to login providing username and password credentials to the login page (90);

(2) The bank server(s) (12) validate the provided credentials against previously stored user credential data;

(3) The user directs the mobile banking application (64) to request a single use passcode;

(4) The bank server(s) (12) generate a single use passcode and an associated seed then saves the seed in the mobile registration data;

(5) The bank server(s) (12) then send the single use passcode to the user using an out of band communication method such as to the user's email address or to the user's SMS text account phone number;

(6) The user then enters the single use passcode into the mobile banking application (64) which sends the single use password to the bank server(s) (12) within a specified time limit;

(7) The bank server(s) (12) validate the single use passcode entered by the user 918) against the single use passcode seed that was previously stored in the mobile registration data;

(8) If the single use passcode is valid, the user (18) is given the option of proceeding into the mobile banking application (64) or remembering the mobile electronic device (16);

(9) If the user (18) chooses “remember the mobile electronic device”, this choice is sent to the bank server(s) (12) which generates a permanent authentication seed (154) and stores it in the mobile registration data along with a unique serial number for this mobile electronic device (16); and

(10) The bank servers (12) also send the permanent authentication seed (154) and the unique serial number back to the mobile banking application (64) which stores them in the memory module of the mobile electronic device (16).

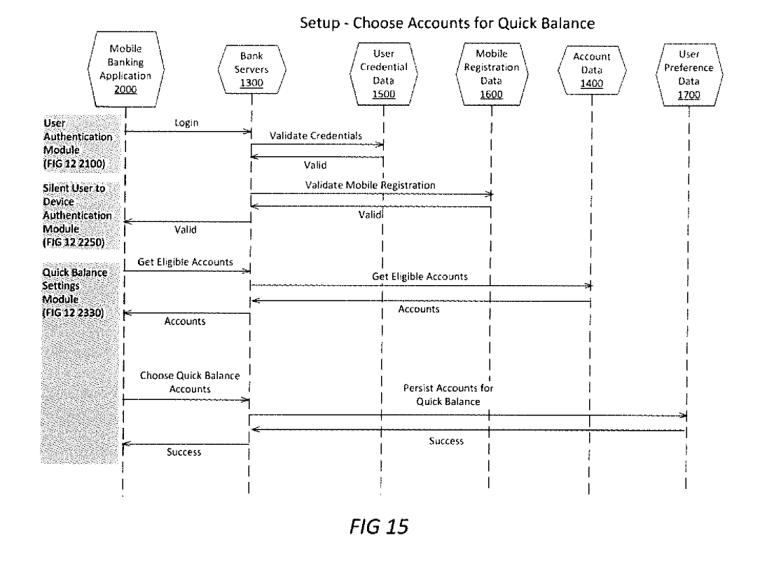

FIG. 15 illustrates a sequence diagram for the illustrated quick balance configuration module. The illustrated sequence of events for configuring quick balance is:

(1) The mobile banking application (64) is directed to login to the bank server(s) (12);

(2) The bank server(s) (12) validates the user's username and password credentials against the previously stored user credential data;

(3) If the username and password credentials are valid, the bank server(s) (12) then validates that a single use token generated from the permanent authentication seed (154) stored on the mobile electronic device (16) matches its expected value derived from a like permanent authentication seed stored in the mobile registration data;

(4) If the token is valid, the user (18) is able to proceed within the mobile banking application (64) to retrieve their eligible accounts from the bank server(s) (12);

(5) The bank server(s) (12) then retrieve the eligible bank accounts from the account data and return them to the mobile banking application (64);

(6) At this point, the user (18) of the mobile banking application (64) can select which of these eligible bank accounts they want displayed in their quick balance display; and

(7) The selected quick balance accounts are sent to the bank server(s) (12) and then persisted in the user preference data.

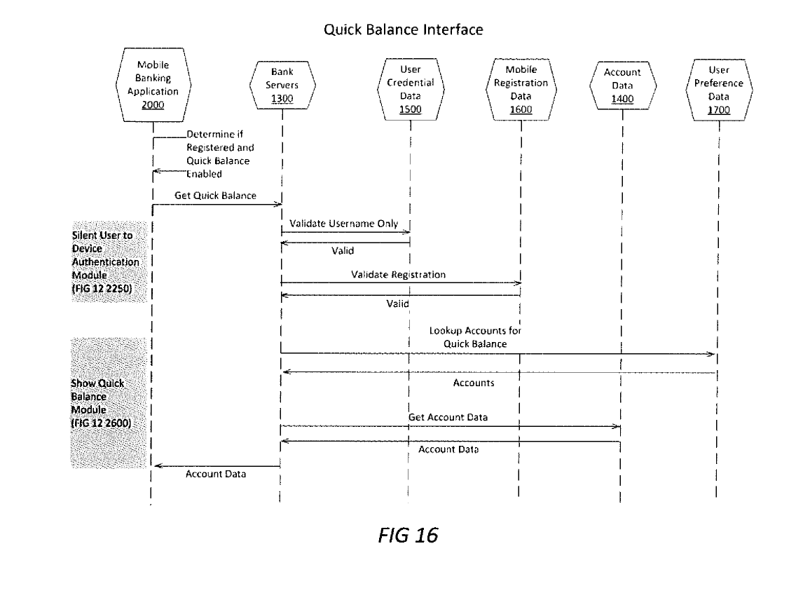

FIG. 16 illustrates a sequence diagram for the quick balance module (76). The illustrated sequence of events to retrieve quick balance is:

(1) The mobile banking application (64) allows a user (18) who has previously registered their mobile electronic device (16) and has previously setup the quick balance module and has saved or entered their username to click on the “quick balance” button (100) on the login page (90);

(2) When they do, the mobile banking application (64) makes a request to get quick balance from the bank server(s) (12);

(3) At this time, the bank server(s) (12) validates only the user's username using the previously stored user credential data;

(4) If the username is valid, the bank server(s) (12) validate that a serial number from an authentication seed previously stored on the memory module of the mobile electronic device (16) matches its expected value stored in the mobile registration data;

(5) If the serial number is valid, the bank server(s) (12) lookup which eligible bank accounts the user (18) has selected for quick balance display from the user preference data and then gets the user's bank account data for those selected eligible accounts from the account data; and

(6) The current bank account balance data is then returned to the mobile banking application for display to the user (18).

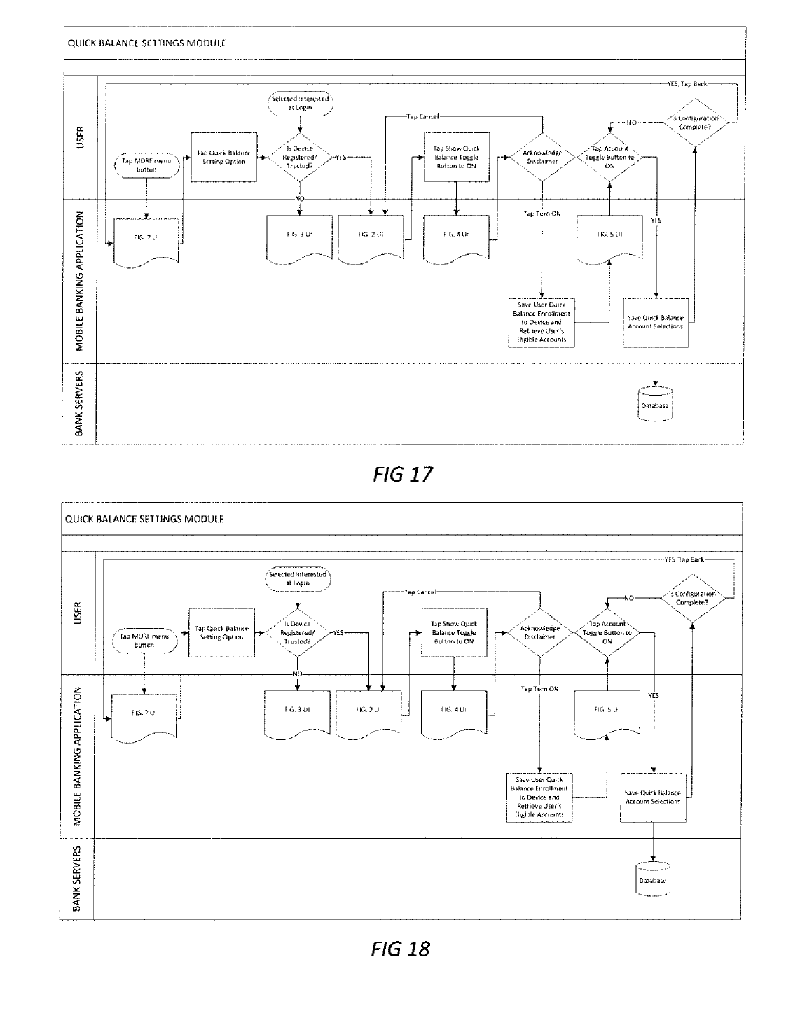

FIG. 17 illustrates a process flow for the illustrated quick balance module (76) showing interaction between the user (18), the mobile banking application (64) and the bank server(s) (12).

FIG. 18 illustrates a process flow for the illustrated quick balance settings module (78) showing interaction between the user (18), the mobile banking application (64) and the bank server(s) (12).

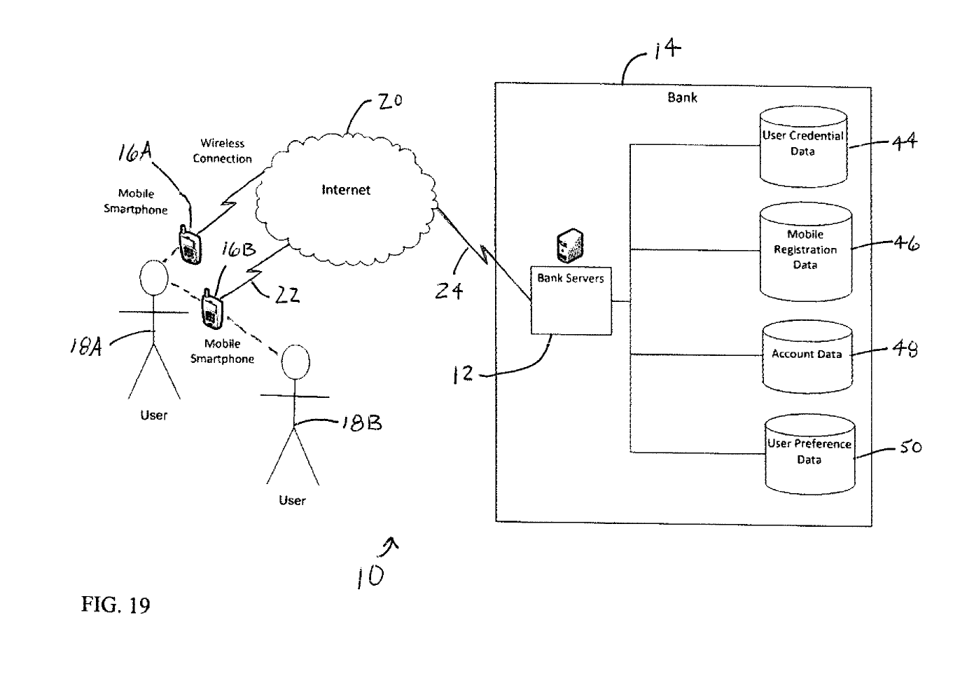

FIG. 19 illustrates that a plurality of users (18A, 18B) can separately authenticate via the login interface (92) of the mobile banking application (64) of a single mobile electronic device 16A. Thus, multiple users (18A, 18B) can share the same mobile electronic device (16A) and each utilize the quick balance feature of the mobile banking application (64). Also, a user (18A) can authenticate and register a plurality of mobile electronic devices (16A, 16B) to the same user account. Thus, a single user (18A) can have several mobile electronic devices (16A, 16B) such as a smartphone and tablet, and utilize the separate mobile electronic devices (16A, 16B) with a single user account. If a mobile electronic device (16A, 16B) is registered/trusted to a particular user (18A) and the quick balance module (76) is enabled on that particular mobile electronic device (16A, 16B), as long as the user's username is correctly entered and validated, the quick balance module (76) will display upon quick balance module activation by that user (18A).

Any of the features or attributes of the above described embodiments and variations can be used in combination with any of the other features and attributes of the above described embodiments and variations as desired for that user's saved preferences.

It is apparent from the above detailed description of preferred embodiments of the present invention, that the above-disclosed systems, methods, and software facilitate electronic banking to quickly and securely provide current bank account balances to mobile electronic devices (16) while providing positive user experience.

It is also apparent from the above detailed description of preferred embodiments of the present invention, that the above-disclosed systems, methods, and software can be modified to include additional or alternative features.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A computer implemented method for facilitating mobile banking, said method comprising the steps of, in combination:
electronically receiving, from a mobile electronic device, a username and a request to receive at least one financial account balance while a user associated with the username is not fully logged-in;
wherein full log-in requires receipt and validation of the username and an associated password.
electronically validating the username;
electronically validating registration of the mobile electronic device;
if the username is valid and the registration of the mobile electronic device is valid, electronically obtaining data for the at least one financial account balance; and
after electronically obtaining the data for the at least one financial account balance, electronically sending the data for the at least one financial account balance to the mobile electronic device for display.

2. The computer implemented method of claim 1, wherein the step of validating the username includes validating that the username received with the request matches a previously stored username.

3. The computer implemented method of claim 2, further comprising the step of, prior to receiving the request, electronically receiving the username from a user and storing the username.

4. The computer implemented method of claim 1, wherein the step of validating registration of the device is performed after the step of determining if the username is valid, and further including the step of denying the request if the username is invalid.

5. The computer implemented method of claim 1, wherein the step of validating registration of the mobile electronic device includes validating that a serial number from an authentication seed previously stored in the mobile electronic device matches an expected value associated with the username; and further including the step of denying the request if the serial number from the authentication seed previously stored in the mobile electronic device does not match an expected value associated with the username.

6. The computer implemented method of claim 5, further comprising the step of prior to receiving the request, electronically generating the permanent authentication seed and sending the permanent authentication seed to the mobile electronic device for storage.

7. The computer implemented method of claim 5, wherein the serial number can be associated with more than one username.

8. A system for facilitating mobile banking, said system comprising, in combination:
at least one central computer having memory, a processor in communication with the memory, and a network interface in communication with the processor for communicating with mobile electronic devices; and
wherein the memory comprising computer-executable instructions executable by the processor to perform the following steps:
electronically receiving, from a mobile electronic device, a username and a request to receive at least one financial account balance while a user associated with the username is not full logged-in;
wherein fully log-in requires receipt and validation of the username and an associated password.
electronically validating the username;
electronically validating registration of the mobile electronic device;
if the username is valid and the registration of the mobile electronic device is valid, electronically obtaining data for the at least one financial account balance; and
after electronically obtaining the data for the at least one financial account balance, electronically sending the data for the at least one financial account balance to the mobile electronic device for display.

9. The system of claim 8, wherein the step of validating the username includes validating that the username received with the request matches a previously stored username.

10. The system of claim 9, further comprising the step of, prior to receiving the request, electronically receiving the username from a user and storing the username.

11. The system of claim 1, wherein the step of validating registration of the device is performed after the step of determining if the username is valid, and further including the step of denying the request if the username is invalid.

12. The system 1, wherein the step of validating registration of the mobile electronic device includes validating that a serial number from an authentication seed previously stored in the mobile electronic device matches an expected value associated with the username; and further including the step of denying the request if the serial number from the authentication seed previously stored in the mobile electronic device does not match an expected value associated with the username.

13. The computer implemented method of claim 12, further comprising the step of, prior to receiving the request, electronically generating the permanent authentication seed and sending the permanent authentication seed to the mobile electronic device for storage.

14. The computer implemented method of claim 12, wherein the serial number can be associated with more than one username.

15. One or more computer-readable media storing an application for facilitating mobile banking comprising computer-executable instructions that responsive to execution cause operations to be performed comprising, in combination:
electronically receiving, from a mobile electronic device, a username and a request to receive at least one financial account balance while a user associated with the username is not fully logged-in;
wherein full log-in requires receipt and validation of the username and an associated password.
electronically validating the username;
electronically validating registration of the mobile electronic device;
if the username is valid and the registration of the mobile electronic device is valid, electronically obtaining data for the at least one financial account balance; and
after electronically obtaining the data for the at least one financial account balance, electronically sending the data for the at least one financial account balance to the mobile electronic device for display.

16. The one or more computer-readable media of claim 15, wherein the step of validating the username includes validating that the username received with the request matches a previously stored username.

17. The one or more computer-readable media of claim 16, further comprising the step of, prior to receiving the request, electronically receiving the username from a user and storing the username.

18. The one or more computer-readable media of claim 15, wherein the step of validating registration of the device is performed after the step of determining if the username is valid, and further including the step of denying the request if the username is invalid.

19. The computer implemented method of claim 15, wherein the step of validating registration of the mobile electronic device includes validating that a serial number from an authentication seed previously stored in the mobile electronic device matches an expected value associated with the username; and further including the step of denying the request if the serial number from the authentication seed previously stored in the mobile electronic device does not match an expected value associated with the username.

20. The computer implemented method of claim 19, further comprising the step of, prior to receiving the request, electronically generating the permanent authentication seed and sending the permanent authentication seed to the mobile electronic device for storage.

21. The computer implemented method of claim 19, wherein the serial number can be associated with more than one username.
